(19) United States
(12) Patent Application Publication
(10) Pub. No.: US 2014/0304979 A1
(43) Pub. Date: Oct. 16, 2014

(54) DISK DRIVE DEVICE MANUFACTURING METHOD

(71) Applicant: SAMSUNG ELECTRO-MECHANICS JAPAN ADVANCED TECH CO., LTD., Fujieda City (JP)

(72) Inventors: Mitsuo KODAMA, Fujieda City (JP); Masafumi MIZUNO, Yaizu City (JP); Kazuhiko NAKATANI, Fujieda City (JP); Masato MORIMOTO, Neyagawa City (JP)

(73) Assignee: SAMSUNG ELECTRO-MECHANICS JAPAN ADVANCED TECH CO., LTD., Fujieda City (JP)

(21) Appl. No.: 14/250,229

(22) Filed: Apr. 10, 2014

(30) Foreign Application Priority Data
Apr. 12, 2013 (JP) 2013-083430

(51) Int. Cl. G11B 25/04

(52) U.S. Cl. CPC G11B 25/043
USPC 29/603.03

(57) ABSTRACT

A disk drive device includes a base, a hub on which a recording disk is to be mounted, and a fluid dynamic bearing unit that supports the hub in a freely rotatable manner relative to the base. The hub includes a hub protrusion to be engaged with the center hole of the recording disk, and amount portion on which the recording disk is to be mounted. A manufacturing method of this disk drive device applies electromechanical machining to the hub protrusion to form an electromechanical machined surface.

### BACKGROUND OF THE INVENTION

1. Field of the Invention

The present disclosure relates to a manufacturing method of a disk drive device that rotates a recording disk.

2. Description of the Related Art

Disk drive devices like a hard disk drive are becoming downsized but are increasing the capacity, and are placed in various electronic devices. In particular, placement of disk drive devices in portable electronic devices, such as a laptop computer and a portable music player, is advancing.

Some disk drive devices like a hard disk drive have a magnetic recording disk mounted on a hub and rotate and drive such a recording disk at a fast speed. For example, JP 2012-163203 A and JP 2012-193839 A disclose a disk drive device provided with a fluid dynamic bearing unit including a shaft body fixed to a base, and a bearing body that rotates together with a hub and that encircles the shaft body.

Recent thinning trends of portable electronic devices are remarkable, and there is a demand for disk drive devices to further increase the recording capacity together with the thinning. An example technology satisfying this demand is to increase a recording density.

To increase the recording density, a clearance between a recording/playing head and a disk surface is reduced. When, however, this clearance is too small, even if minute particles stick to the disk surface, it becomes unable for the recording/playing head to precisely trace tracks on the disk, resulting in a read/write failure. In the worst case, the recording/playing head is damaged, and thus the disk drive device breaks down.

A cause of such particles is peeled materials produced by peeled pieces from the surface of a hub on which the magnetic recording disk is mounted. In particular, possible peel-out materials, such as burrs at the time of cutting and machining, and minute protrusions of contained constituents, are sticking to, in particular, the outer circumference of a cylindrical portion of a hub with which the center hole of the magnetic recording disk. Hence, there is a concern that the possible peel-out materials are peeled when the center hole is engaged. In order to suppress a peeling of the possible peel-out materials and an increase of the particles, it is desirable to decrease the possible peel-out materials. However, when, for example, the hub is rotated, and a tool, etc., is caused to contact therewith to mechanically eliminate the possible peel-out materials, new possible peel-out materials may be produced adversely.

The present disclosure has been made in view of the aforementioned circumstances, and it is an object of the present disclosure to provide a disk drive device which allows effective elimination of possible peel-out materials on the surface of a hub, and which is suitable for increasing a recording density.

### SUMMARY OF THE INVENTION

To accomplish the above objective, an aspect of the present invention provides a manufacturing method of a disk drive device that includes: a base; a hub including a hub protrusion to be engaged with a center of the recording disk, and a mount portion on which the recording disk is to be mounted; and a fluid dynamic bearing unit that supports the hub in a freely rotatable manner relative to the base, the method including: cutting a surface of the hub protrusion; and applying electromechanical machining to an outer circumference of the cut-out hub protrusion.

To accomplish the above objective, a second aspect of the present invention provides a manufacturing method of a disk drive device that includes: a base; a hub including a hub protrusion to be engaged with a center of the recording disk, a mount portion on which the recording disk is to be mounted, and a thread formed on an outer circumference of the hub protrusion; and a fluid dynamic bearing unit that supports the hub in a freely rotatable manner relative to the base, the method including: cutting a surface of the hub protrusion; and applying electromechanical machining to the outer circumference of the cut-out hub protrusion.

To accomplish the above objective, a third aspect of the present invention provides a manufacturing method of a disk drive device that includes: a base; a hub including a hub protrusion to be engaged with a center of the recording disk, a mount portion on which the recording disk is to be mounted, and a thread formed on an outer circumference of the hub protrusion; and a fluid dynamic bearing unit that supports the hub in a freely rotatable manner relative to the base, the method including: cutting a surface of the hub protrusion; and shooting shot abrasives to the cut-out hub protrusion.

Any combination of the aforementioned structural components and a mutual replacement of the structural component and expression of the present disclosure between the method, a device, a system, etc., is also advantageous as an aspect of the present disclosure.

### BRIEF DESCRIPTION OF THE DRAWINGS

FIG. 1 is an exploded perspective view illustrating disk drive device according to an embodiment of the present disclosure;

FIG. 2 is a cross-sectional view mainly illustrating a left part of a cross section taken along a line A-A in FIG. 1;

FIG. 3 is an enlarged diagram illustrating part of FIG. 2 in an enlarged manner; and

FIG. 4 is an exemplary diagram for explaining an electrolytic process on a hub.

### DETAILED DESCRIPTION OF THE PREFERRED EMBODIMENTS

The same or corresponding element and member illustrated in respective drawings will be denoted by the same reference numeral below, and the duplicated explanation will be omitted accordingly. In addition, the dimension of a member in each drawing is indicated in an enlarged/scaled-down manner as needed to facilitate understanding to the present disclosure. Still further, a portion of a member not important to explain an embodiment will be illustrated in an omitted manner.

A disk drive device according to an embodiment is suitably applied as a disk drive device like a hard disk drive that is loaded with a magnetic recording disk which magnetically records data, and that rotates and drives the recording disk. For example, this disk drive device includes a rotator that is attached to a stationary body in a freely rotatable manner through a bearing. The rotator includes a loader that can load a drive-target medium like the magnetic recording disk. The bearing includes, for example, a radial bearing provided at either the stationary body or the rotator. In addition, the bearing includes, for example, a thrust bearing provided at either the stationary body or the rotator. As an example, the thrust bearing is located outwardly in a radial direction relative to the radial bearing. For example, the radial bearing and the thrust bearing generate dynamic pressure of a lubricating medium. For example, the radial bearing and the thrust bearing may contain a lubricating fluid. Still further, this disk drive device includes a rotational driver that applies rotational torque to the rotator. The rotational driver includes, for example, a brushless spindle motor. The rotational driver includes, for example, coils and a magnet.

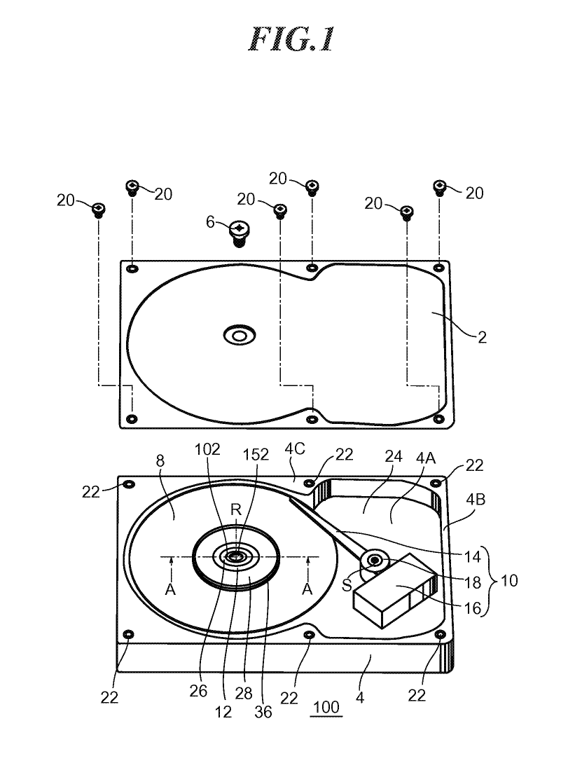

FIG. 1 is a perspective view illustrating a disk drive device 100 of this embodiment. In FIG. 1, a top cover 2 is detached in order to facilitate understanding to the present disclosure. Elements not important to explain the present disclosure like an electronic circuit are omitted in FIG. 1. The disk drive device 100 includes a stationary body, a rotator that rotates relative to the stationary body, a magnetic recording disk 8 attached to the rotator, and a data reader/writer 10. The stationary body includes a base 4, a shaft 26 fixed to the base 4, a housing 102 supporting the shaft 26, the top cover 2, six screws 20, and a shaft fastening screw 6. The rotator includes a hub 28, a clamper 36, and a cover ring 12.

In the following explanation, a side at which the hub 28 is mounted relative to the base 4 will be defined as an upper side.

The magnetic recording disk 8 is, for example, a 2.5-inch magnetic recording disk formed of glass and having a diameter of 65 mm. The diameter of a center hole is 20 mm, and the thickness is 0.65 mm. One magnetic recording disk 8 is to be mounted on the hub 28.

The base 4 is formed and shaped by, for example, die-casting of an aluminum alloy. The base 4 includes a bottom portion 4A forming the bottom of the disk drive device 100, and an outer circumference wall 4B formed along the outer circumference of the bottom portion 4A so as to encircle an area where the magnetic recording disk 8 is mounted. For example, six screw holes 22 are provided in an upper face 4C of the outer circumference wall 4B. The base 4 may be formed by pressing of a steel sheet or an aluminum sheet.

A surface coating is applied to the base 4 in order to suppress a peeling from the surface. An example surface coating applied is a resin-material coating like an epoxy resin. As a surface coating, instead of the resin material, a metal material, such as nickel or chrome, may be applied as coating by plating. In this embodiment, the base 4 has the surface having undergone electroless nickel plating. In comparison with a case in which the resin material is applied as a coating, the surface hardness is enhanced to decrease a friction coefficient. Hence, when, for example, the magnetic recording disk 8 contacts the surface of the base 4 at the time of manufacturing, the possibility that the surface of the base 4 is damaged can be reduced. In this embodiment, the surface of the base 4 has a static friction coefficient is within a range from 0.1 TO 0.6. In comparison with a case in which the static friction coefficient is equal to or greater than 2, the possibility that the base 4 is damaged can be further reduced.

The data reader/writer 10 includes an unillustrated recording/playing head, a swing arm 14, a voice coil motor 16, and a pivot assembly 18. The recoding/playing head is attached to the tip of the swing arm 14, records data in the magnetic recording disk 8, or reads the data therefrom. The pivot assembly 18 supports the swing arm 14 in a swingable manner to the base 4 around a head rotating shaft S. The voice coil motor 16 allows the swing arm 14 to swing around the head rotating shaft S to move the recording/playing head to a desired location over the top face of the magnetic recording disk 8. The voice coil motor 16 and the pivot assembly 18 are configured by a conventionally well-known technology of controlling the position of a head.

The top cover 2 covers the rotator. The top cover 2 is fastened to the upper face 4C of the outer circumference wall 4B of the base 4 using, for example, six screws 20. The six screws 20 correspond to the six screw holes 22. In particular, the top cover 2 and the upper face 4C of the outer circumference wall 4B are fastened together in such a way that no leak to the interior of the disk drive device 100 occurs from the joined portion therebetween. The interior of the disk drive device 100 is, more specifically, a clean space 24 surrounded by the bottom portion 4A of the base 4, the outer circumference wall 4B thereof, and the top cover 2. This clean space 24 is designed so as to be air-tightly sealed, i.e., so as to have no leak-in from the exterior and leak-out to the exterior. The clean space 24 is filled with a clean filler gas having particles eliminated. Example filler gases are various gases including air. In this embodiment, a gas with a smaller molecular weight than nitrogen, such as helium or hydrogen, is filled in the clean space 24.

The shaft 26 runs along a rotational axis of the hub 28. A shaft-fastening-screw hole 152 is provided in the upper end face of the housing 102. The shaft fastening screw 6 passes all the way through the top cover 2, and is engaged with the shaft-fastening-screw hole 152, thereby fastening the top cover 2 to the shaft 26.

According to the disk drive device having both ends of the shaft 26 fixed to the chassis including the top cover 2 and the base 4 as explained above among fixed-shaft type disk drive devices, the shock resistance of the disk drive device and the vibration resistance thereof can be enhanced.

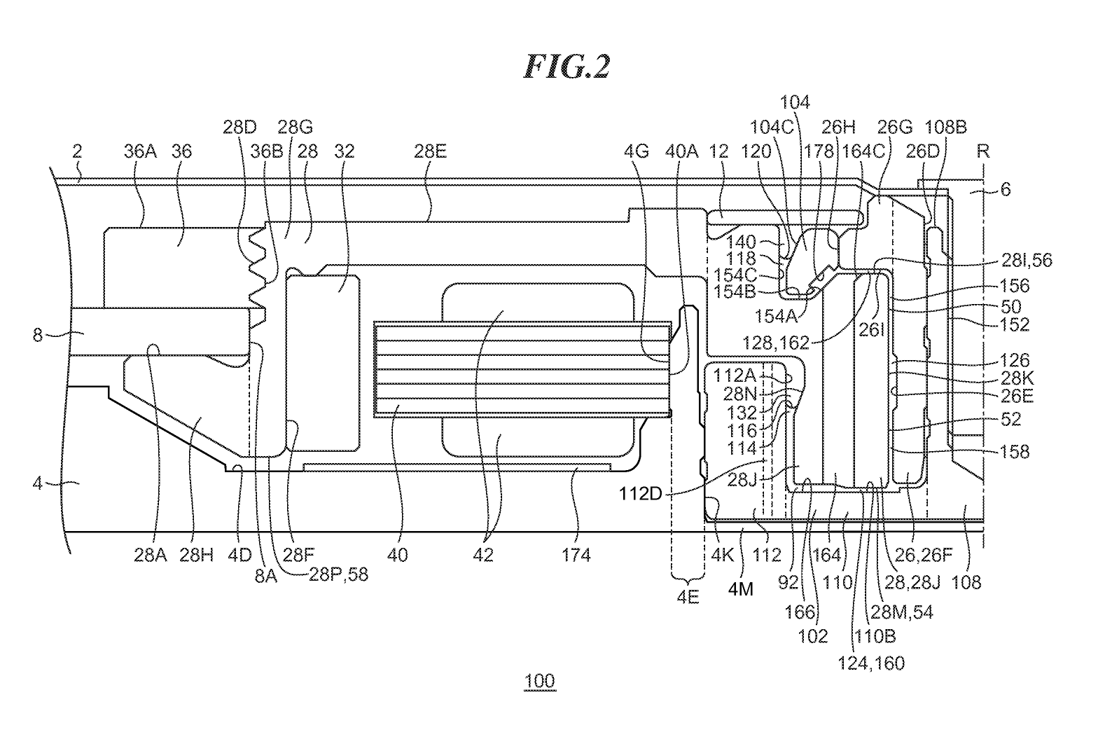

FIG. 2 is a cross-sectional view mainly illustrating the left part of the cross section taken along a line A-A in FIG. 1. The cross section illustrated in FIG. 2 corresponds to a half cross section of a motor component in the disk drive device 100.

The rotator includes the hub 28, the clamper 36, a cylindrical magnet 32, and the cover ring 12. The stationary body includes the base 4, a laminated core 40, coils 42, the housing 102, the shaft 26, and a ring portion 104. A lubricant 92 is continuously present in some gaps between the rotator and the stationary body.

The hub 28 is formed by, for example, cutting and machining or pressing a ferrous material with a soft magnetism like SUS 430, and is formed in a predetermined shape like a substantially cup shape. In order to suppress a peeling from the surface, a surface layer forming process like electroless nickel plating may be applied to the hub 28. The hub 28 includes a shaft encircling portion 28J that encircles the shaft 26, a hub protrusion 28G that is provided outwardly in the radial direction relative to the shaft encircling portion 28J, and to be engaged with the center hole 8A of the magnetic recording disk 8, and, a mount portion 28H provided outwardly in the radial direction relative to the hub protrusion 28G. The hub 28 is provided with gas dynamic pressure generating grooves 58 formed in a lower face 28P of the mount portion 28H and formed in, for example, an inward-direction spiral shape. When the hub 28 rotates, the gas dynamic pressure generating grooves 58 generate inward dynamic pressure in the gas like air present between the mount portion 28H and the base 4, thereby pushing inwardly the lubricant 92 vaporized from a first gas-liquid interface 116. The gas dynamic pressure generating grooves 58 can be formed by various techniques, such as rolling, pressing, cutting or etching. In this embodiment, the gas dynamic pressure generating grooves 58 are formed by electromechanical machining, and include an electromechanical machined surface.

The magnetic recording disk 8 is to be mounted on a disk mount face 28A that is the upper face of the mount portion 28H. The magnetic recording disk 8 is held between the clamper 36 and the mount portion 28H, thereby being fastened to the hub 28. The clamper 36 applies downward force in the axial direction to the upper face of the magnetic recording disk 8 to cause the magnetic recording disk 8 to be in contact with the disk mount face 28A in a pressed manner against it. The clamper 36 is engaged with an outer circumference 28D of the hub protrusion 28G. The clamper 36 and the outer circumference 28D of the hub protrusion 28G can be joined together by mechanical joining techniques, such as screwing, caulking, and press-fitting, or a magnetic joining technique utilizing magnetic suction force.

The clamper 36 is disposed in such a way that, with the clamper 36 applying desired downward force to the magnetic recording disk 8, an upper face 36A of the clamper 36 does not protrude beyond an upper face 28E of the hub protrusion 28G.

When, for example, a structure is employed in which the clamper 36 and the outer circumference 28D of the hub protrusion 28G are engaged by screwing, a male screw is formed on the outer circumference 28D of the hub protrusion 28G, while a counterpart female screw is formed in an inner circumference 36B of the clamper 36. In this case, depending on the strength of the screwing, the tension of the downward force applied by the clamper 36 to the upper face of the magnetic recording disk 8 can be relatively precisely adjusted to desired tension. The clamper 36 may be formed of multiple pieces, or may be a single piece.

Next, an explanation will be given of a peeling from the surface of the hub protrusion 28G.

Process burrs and minute protrusions of contained constituents like a so-called free-machining material sometimes stick to the surface of the hub protrusion 28G. In particular, when the outer circumference 28D of the hub protrusion 28G includes non-continuous processed areas like grooves, process burrs are highly possibly stick thereto. When stress is applied, such process burrs and minute protrusions may become possible peel-out materials that will be easily peeled. When the hub protrusion 28G to which possible peel-out materials stick is engaged with the center hole 8A of the magnetic recording disk 8, the possible peel-out materials are peeled from the hub protrusion 28G and may become particles.

When, in particular, the outer circumference 28D of the hub protrusion 28G includes a male-screw formed area, the possibility that the process burrs stick thereto becomes further high. When the hub protrusion 28G having the male-screw formed area to which the possible peel-out materials stick is engaged with the inner circumference of the clamper 36 by screwing, the possible peel-out materials at the male-screw formed area are peeled from the hub protrusion 28G, and become particles.

The particles originating from the sticking materials to the surface of the hub 28 possibly have a high hardness, and when such particles stick to the surface of the magnetic recording disk 8, it becomes difficult for the recording/playing head to precisely trace tracks on the disk, causing a read/write failure. In the worst case, the recording/playing head is damaged, resulting in a breakdown of the disk drive device.

In order to address such a technical problem inherent to the possible peel-out materials like process burrs, the disk drive device 100 has an electromechanical machined surface in the outer circumference 28D of the hub protrusion 28G with possible peel-out materials eliminated by electromechanical machining. According to such a structure, it becomes possible to suppress particles originating from the outer circumference 28D of the hub protrusion 28G. In order to further suppress particles originating from the hub 28, the hub 28 may have an electromechanical machined surface other than the hub protrusion 28G. In this embodiment, in particular, the disk mount face 28A of the mount portion 28H includes an electromechanical machined surface having possible peel-out materials eliminated by electromechanical machining.

Possible peel-out materials may stick to the outer circumference of the hub protrusion 28G, the upper face 28E thereof, and the disk mount face 28A. In order to eliminate such possible peel-out materials, at least one of the outer circumference 28D of the hub protrusion 28G, the disk mount face 28A, and the upper face 28E of the hub protrusion 28G may have a part to which electromechanical machining is applied. In a process of manufacturing the disk drive device of this embodiment, the outer circumference 28D of the hub protrusion 28G, the disk mount face 28A, and the upper face 28E of the hub protrusion 28G are subjected to electromechanical machining.

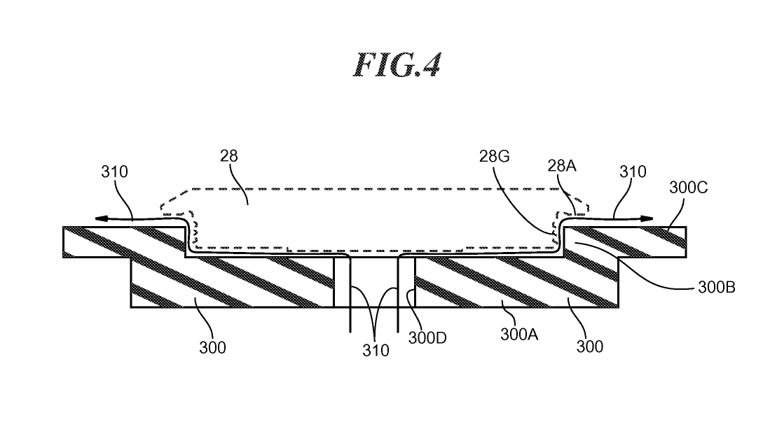

Next, an explanation will be given of the electromechanical machining. FIG. 4 is an exemplary diagram for explaining an example electromechanical machining applied to the hub 28. The hub 28 is supported with a predetermined clearance being maintained from a process electrode 300, an electrolytic solution 310 is caused to flow through such a clearance. The hub 28 is set as a positive electrode, while the process electrode 300 is set as a negative electrode, and a predetermined voltage applied to electrochemically eliminate possible peel-out materials. As viewed from the top, the process electrode 300 is formed in a substantially cup shape that includes a circular electrode disk 300A, an electrode cylinder 300B extending upwardly from the outer circumference of the electrode disk 300A, and an electrode flange 300C extending outwardly in the radial direction from the upper end of the electrode cylinder 300B. An electrode hole 300D is provided in the center of the electrode disk 300A. The hub protrusion 28G is fitted in the electrode cylinder 300B, and the electrode flange 300C supports the disk mount face 28A with the aid of unillustrated spacer formed of an insulating material. The upper face of the electrode disk 300A faces the upper face 28E of the hub protrusion 28G with a clearance of 0.1 mm. The inner circumference of the electrode cylinder 300B faces the outer circumference of the hub protrusion 28G with a clearance of 10 μm to 20 μm in the radial direction. The upper face of the electrode flange 300C faces the disk mount face 28A with a clearance of 0.3 to 2 mm.

As an example, the electrolytic solution 310 flows in through the electrode hole 300D, and spreads in the outer circumferential direction through the clearance between the electrode disk 300A and the hub protrusion 28G, the clearance between the electrode cylinder 300B and the disk mount face 28A, and the clearance between the electrode flange 300C and the disk mount face 28A. When a voltage is applied in such a condition, the outer circumference 28D of the hub protrusion 28G, the disk mount face 28A, and the upper face 28E of the hub protrusion 28G are subjected to electromechanical machining, and thus the possible peel-out materials are eliminated. As to the process level of the electromechanical machining, for example, the decreased dimension of the outer circumference 28D of the hub protrusion 28G by the electromechanical machining is 10 μm to 30 μm, and the decreased dimension of the disk mount face 28A by the electromechanical machining is 1 μm to 5 μm. That is, the electromechanical machining level of the outer circumference 28D of the hub protrusion 28G is larger than that of the disk mount face 28A. In comparison with a case in which the disk mount face 28A has a larger electromechanical machining level, the clearance between the electrode flange 300C and the disk mount face 28A can be increased, and thus the electrolytic solution 310 can smoothly flow and spread, thereby decreasing the process time.

Returning to FIG. 2, the cylindrical magnet 32 is bonded and fastened to a cylindrical inner circumference 28F of the hub 28 corresponding to the internal cylindrical face thereof. The cylindrical magnet 32 is formed of, for example, a rare-earth magnetic material or a ferrite magnetic material. In this embodiment, the cylindrical magnet 32 is formed of a neodymium-based rare-earth magnetic material. The cylindrical magnet 32 has, for example, 12 driving polarities in the circumferential direction thereof (a tangent line direction of a vertical circle to the rotation axis R and around it). The cylindrical magnet 32 faces, for example, nine salient poles of the laminated core 40 in the radial direction (i.e., a direction orthogonal to the rotation axis R).

The laminated core 40 includes an annular part and the nine salient poles extending therefrom outwardly in the radial direction, and is fixed on an upper-face-4D side of the base 4. The laminated core 40 is formed by, for example, laminating six thin magnetic steel sheets each having a thickness of 0.2 mm, and caulking and integrating those sheets together. The laminated core 40 may be formed by laminating, for example, 2 to 20 thin magnetic steel sheets each having a thickness of 0.1 to 0.8 mm. An insulation coating is applied to the surface of the laminated core 40 by, for example, electrodeposition coating or powder coating. A coil 42 is wound around each salient pole of the laminated core 40. When three-phase substantially sinusoidal drive currents are caused to flow through the respective coils 42, drive magnetic fluxes are generated along the salient poles. It is confirmed that the performance and the costs are in the practical range when the thickness dimension of the laminated core 40 is within a range from 80 to 300% of the thickness dimension of the cylindrical magnet 32. In this embodiment, the thickness dimension of the laminated core 40 is within a range from 160 to 240% of the thickness dimension of the cylindrical magnet 32. A stable rotation can be ensured with practical costs.

The base 4 includes an annular base protrusion 4E around the rotation axis R of the rotator. The base protrusion 4E protrudes upwardly so as to encircle the housing 102. When a center hole 40A of the annular part of the laminated core 40 is engaged with an outer circumference 4G of the base protrusion 4E, the laminated core 40 is fixed to the base 4. In particular, the annular part of the laminated core 40 is bonded and fixed to the base protrusion 4E by press-fitting or loose fitting. In this embodiment, in order to suppress a vibration of the laminated core 40, 60 to 90% of the thickness dimension of the annular part of the laminated core 40 in the axial direction contacts the outer circumference to the base protrusion 4E in a pressed manner against it.

The base 4 is provided with a bearing hole 4K around the rotation axis R. The bearing hole 4K can be a through-hole or a non through-hole. In this embodiment, the bearing hole 4K is a non through-hole in order to enhance the air tightness of the clean space 24. That is, the lower end of the bearing hole 4K is plugged by a bottom 4M. The bottom 4M can be fastened to the bearing hole 4K by a bond after the bottom 4M is formed separately from the base 4. In this embodiment, the bottom 4M is formed integrally in a seamless manner with the base 4 so as to further enhance the air tightness.

When the bearing hole 4K is a through-hole, for example, a sheet member can be pasted on the lower face of the base 4 so as to cover the bearing hole 4K.

Portions of the upper face 4D of the base 4 corresponding to the salient poles and the coils 42 are provided with a resin-made insulating sheet or tape 174 like PET.

The housing 102 includes a flat and annular housing bottom 110, a cylindrical base-side encircling portion 112 fixed to the outer circumference of the housing bottom 110, and a supportive protrusion 108 fixed to the inner circumference of the housing bottom 110 and extending along the rotation axis R. The housing 102 forms an annular recess 166 where the lower end of the shaft encircling portion 28J enters together with the shaft 26.

The base-side encircling portion 112 is encircled by the base protrusion 4E. The base-side encircling portion 112 is fitted in the bearing hole 4K formed in the base 4, and is fixed to, in particular, the bearing hole 4K by a bond.

A bottom-face-side space is formed in a clearance between the lower face of the housing bottom 110 and the upper face of the bottom 4M. When the housing bottom 110 is inserted in the bearing hole 4K, gas in the lower-face-side space is compressed, which pushes out the housing bottom 110, disturbing an inserting work. In this embodiment, a gas passage 112D passing all the way through from the lower face of the base-side encircling portion 112 to the upper face thereof is formed. Hence, the gas in the lower-face-side space is repelled through the gas passage 112D to a space between the hub 28 and the base 4, thus facilitating the inserting work.

The shaft 26 is formed with a support hole 26D that is a through-hole around the rotation axis R. The support protrusion 108 is inserted in and fixed to the support hole 26D. In other words, the shaft 26 encircles the support protrusion 108, and is fixed to the support protrusion 108.

Formed in an upper end face 108B of the support protrusion 108 along the rotation axis R is a shaft-fastening-screw hole 152 that is a non through-hole and is a screw hole. The shaft fastening screw 6 enters the shaft-fastening-screw hole 152, and is engaged therewith by screwing. Screwing and bonding may be both applied simultaneously in order to enhance the joining strength. An explanation will now be given of a positional relationship among the shaft 26, the support protrusion 108, and the shaft fastening screw 6. The support protrusion 108 is held in the radial direction between the shaft 26 and the shaft fastening screw 6, or is present between the shaft 26 and the shaft fastening screw 6. The shaft fastening screw 6 does not contact the shaft 26, but is indirectly fastened to the shaft 26.

The shaft 26 includes a body 26F extending along the rotation axis R and encircling the support protrusion 108, and a flange 26G extending outwardly in the radial direction from the upper end of the body 26F.

The ring 104 encircles the flange 26G, and fixed to an outer circumference 26H of the flange 26G. The ring 104 is fixed to the flange 26G by both press-fitting and bonding. A bond between the ring 104 and the flange 26G also serves as a seal that seals a clearance between the ring 104 and the flange 26G to suppress a leak-out of the lubricant 92.

The shaft encircling portion 28J encircles the body 26F. The lubricant 92 is present between the shaft encircling portion 28J and the body 26F. That is, an inner circumference 28K of the shaft encircling portion 28J and an outer circumference 26E of the body 26F face with each other via a first gap 126 which is filled with the lubricant 92. In this embodiment, the lubricant 92 contains fluorescent materials, and when, for example, input light like ultraviolet ray is emitted, the lubricant emits visible light like blue or green light with a difference wavelength from that of the input light.

The shaft encircling 28J is held between the flange 26G and the ring 104, and, the housing 102 in the axial direction (i.e., the direction parallel to the rotation axis R). The lubricant 92 is present between the shaft encircling portion 28J and the ring 104, between the shaft encircling portion 28J and the flange 26G, and between the shaft encircling portion 28J and the housing 102. That is, a flange opposing face 28L of the shaft encircling portion 28J faces a lower face 261 of the flange 26G with a second gap 128 which is filled with the lubricant 92. The flange opposing face 28L is a disk-shaped surface having a normal line substantially parallel with the rotation axis R. A lower face 28M of the shaft encircling portion 28J faces an upper face 110B of the housing bottom 110 via a third gap 124 which is filled with the lubricant 92.

An explanation will now be given of a positional relationship between the base-side encircling portion 112 and the shaft encircling portion 28J. The base-side encircling portion 112 encircles a lower part of the shaft encircling portion 28J. Formed between the base-side encircling portion 112 and the shaft encircling portion 28J is a first tapered seal 114 where a fourth gap 132 between an inner circumference 112A of the base-side encircling portion 112 and a lower outer circumference 28N of the shaft encircling portion 28J becomes gradually widespread toward the upper space. The first tapered seal 114 has a first gas-liquid interface 116 of the lubricant 92, and suppresses a leak-out of the lubricant 92 by a capillary phenomenon.

An annular sleeve recess is formed in the upper face of the shaft encircling portion 28J around the rotation axis R. The sleeve recess is concaved downwardly. The sleeve recess includes a first recessed face 154A extending in the radial direction obliquely downwardly from the outer circumferential edge of the flange opposing face 28L, a second recessed face 154B extending substantially in parallel with the radial direction from the outer circumferential edge of the first recessed face 154A, and a third recessed face 154C extending in the axial direction upwardly from the outer circumferential edge of the second recessed face 154B. The normal line of the first recessed face 154A is in parallel with a direction orthogonal to the axial direction. In particular, the angle between the normal line of the first recessed face 154A and the rotation axis R can be set within a range from 30 to 60 degrees. The ring 104 enters the sleeve recess.

A ninth gap 140 between the third recessed face 154C and an outer circumference 104C of the ring 104 forms a second tapered seal 118 that gradually becomes widespread toward the upper space. The second tapered seal 118 has a second gas-liquid interface 120 of the lubricant 92, and suppresses a leak-out of the lubricant 92 by a capillary phenomenon.

The first gap 126 includes two radial dynamic pressure generating portions 156 and 158 that generate dynamic pressure in the radial direction to the lubricant 92 when the hub 28 rotates relative to the shaft 26. The two radial dynamic pressure generating portions 156 and 158 are spaced apart from each other in the axial direction, and the first radial dynamic pressure generating portion 156 is located above the second radial dynamic pressure generating portion 158. Formed in portions of an inner circumference 28K of the shaft encircling portion 28J corresponding to the two radial dynamic pressure generating portions 156, 158 are first radial dynamic pressure generating grooves 50 and second radial dynamic pressure generating grooves 52 in a herringbone or spiral shape. At least one of the first and second radial dynamic pressure generating grooves 50 and 52 may be formed in an outer circumference 26E of the body 26F instead of the inner circumference 28K of the shaft encircling portion 28J.

The third gap 124 includes a first thrust dynamic pressure generating portion 160 that generates dynamic pressure in the axial direction to the lubricant 92 when the hub 28 rotates relative to the shaft 26. Formed in portion of the lower face 28M of the shaft encircling portion 28J corresponding to the first thrust dynamic pressure generating portion 160 are first thrust dynamic pressure generating grooves 54 in a herringbone or spiral shape. The first thrust dynamic pressure generating grooves 54 may be formed in the upper face 110B of the housing bottom 110 instead of the lower face 28M of the shaft encircling portion 28J.

The second gap 128 includes a second thrust dynamic pressure generating portion 162 that generates dynamic pressure in the axial direction to the lubricant 92 when the hub 28 rotates relative to the shaft 26. Formed in a portion of the flange opposing face 28L of the shaft encircling portion 28J corresponding to the second thrust dynamic pressure generating portion 162 are second thrust dynamic pressure generating grooves 56 in a herringbone or spiral shape. The second thrust dynamic pressure generating grooves 56 may be formed in the lower face 261 of the flange 26G instead of the flange opposing face 28L of the shaft encircling portion 28J.

The radial dynamic pressure generating grooves 50, 52 and the thrust dynamic pressure generating grooves 54, 56 can be respectively formed through various techniques, such as rolling, pressing, cutting or etching. The radial dynamic pressure generating grooves 50, 52 and the thrust dynamic pressure generating grooves 54, 56 can be formed through different techniques.

An area where at least one of the radial dynamic pressure generating grooves 50, 52 and the thrust dynamic pressure generating grooves 54, 56 are formed may include an electromechanical machined surface. In this embodiment, the radial dynamic pressure generating grooves 50, 52 and the thrust dynamic pressure generating grooves 54, 56 are formed by electromechanical machining, and thus the areas where those dynamic pressure generating grooves are formed include electromechanical machined surfaces. According to such a structure, a generation of particles originating from the hub 28 can be further suppressed. In addition, any one of those dynamic pressure generating grooves and the hub protrusion 28G may be formed simultaneously or sequentially by electromechanical machining. This reduces the steps of the labor works.

When the rotator rotates relative to the stationary body, the first and second radial dynamic pressure generating grooves 50, 52 and the first and second thrust dynamic pressure generating grooves 54, 56 produce dynamic pressures to the lubricant 92, respectively. Such dynamic pressures support the rotator in the radial direction and the axial direction in a non-contact manner with the stationary body.

The cover ring 12 is fixed to the hub 28 that is the rotator by bonding so as to cover the second gas-liquid interface 120 present in the ninth gap 140. The cover ring 12 may be fixed to, for example, the flange 26G of the stationary body. The cover ring 12 is formed of, for example, a metal material like stainless steel or a resin material in a ring shape. The cover ring 12 may include a lubricant trap, such as a porous material like a sintered material or a charcoal filter, to trap the lubricant 92 spilled out from the second gas-liquid interface 120 and vaporized. The cover ring 12 may have a portion to trap the lubricant provided so as to face the top cover 2 in the axial direction. This enables an efficient trap of the vaporized lubricant 92 present between the cover ring 12 and the top cover 2.

Formed in the shaft encircling portion 28J is a bypass communication hole 164 that bypasses the second thrust dynamic pressure generating portion 162, the first radial dynamic pressure generating portion 156, the second radial dynamic pressure generating portion 158, and the first thrust dynamic pressure generating portion 160. The bypass communication hole 164 passes all the way through the shaft encircling portion 28J linearly along the axial direction. The lubricant 92 is present in the bypass communication hole 164, and when, in particular, dynamic pressure is unbalanced, the lubricant 92 flows through the bypass communication hole 164. Accordingly, the dynamic pressure becomes balanced. As a result, even if, for example, dynamic pressure to be produced is unbalanced, the levels of the first gas-liquid interface 116 and the second gas-liquid interface 120 can be maintained appropriately.

A portion of the upper-end edge of the bypass communication hole 164 is present in the first recessed face 154A, and the other portions are present in the flange opposing face 28L. An edge opposing face in the surfaces of the ring 104 facing the first recessed face 154A is formed in a shape corresponding to the upper-end edge of the bypass communication hole 164. In particular, the edge opposing face is formed with, at a portion corresponding to the upper-end edge of the bypass communication hole 164, an edge-corresponding recess 178 encircling the rotation axis R. The edge-corresponding recess 178 is formed so as to cover a part of the upper end of the bypass communication hole 164. The edge-corresponding recess 178 prevents edge burrs present at the upper-end edge of the bypass communication hole 164 from contacting the ring 104 and being peeled.

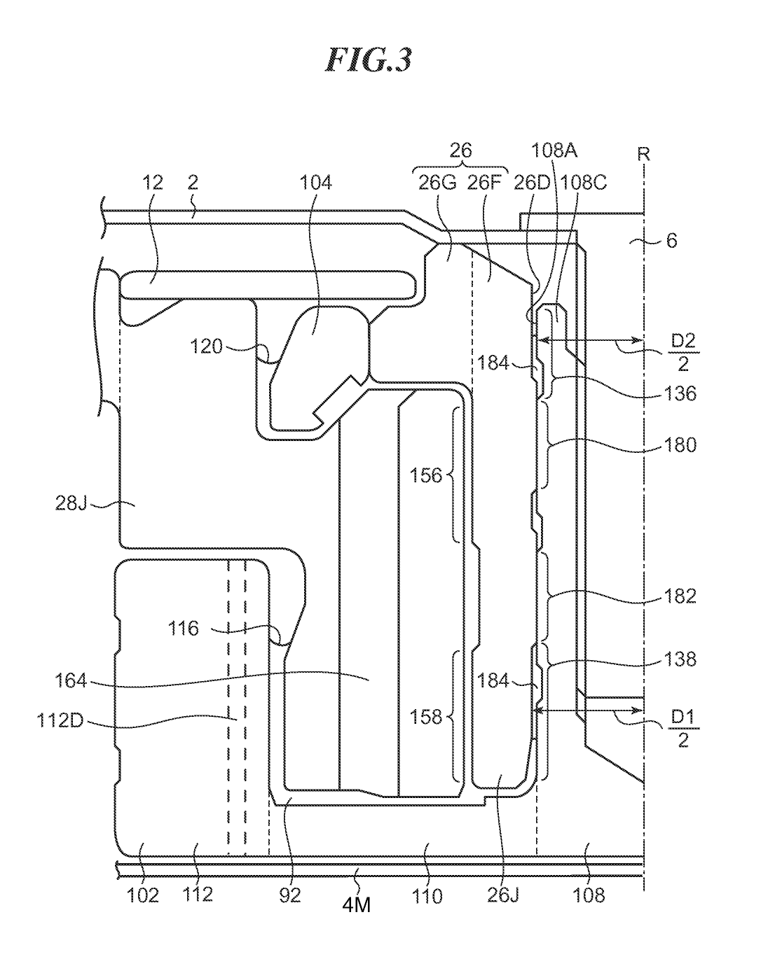

FIG. 3 is an enlarged diagram illustrating a part in FIG. 2 in an enlarged manner. The support protrusion 108 is fixed to the support hole 26D by both press-fitting and bonding. The shaft 26 encircles an upper end 108C of the support protrusion 108 with a seventh gap 136 present therebetween. As to the positional relationship between the flange 26G and the upper end 108C, the flange 26G encircles the upper end 108C.

A lower end 26J of the shaft 26 encircles the support protrusion 108 with an eighth gap 138 present therebetween. A bond 184 is present in the seventh and eighth gaps 136 and 138. The seventh gap 136 has a gap-wide portion and a gap-narrow portion, and the gap-wide portion functions as a bond reservoir that retains the bond 184 therein. The narrow-gap portion may have a width of 20 μm to 30 μm. The eighth gap 138 is formed likewise the seventh gap 136.

A diameter D1 of the circumferential surface of the support hole 26D corresponding to the eighth gap 138 is larger than a diameter D2 of an outer circumference 108A of the support protrusion 108 corresponding to the seventh gap 136. Hence, at an initial stage at which the shaft 26 is fitted with the support protrusion 108, the shaft 26 is fitted with the support protrusion 108 with a play.

The support protrusion 108 is subjected to tight fit with the shaft 26 between the seventh gap 136 and the eighth gap 138. In particular, two tight fit portions 180, 182 where the outer circumference 108A of the support protrusion 108 is tight fitted with the circumferential surface of the support hole 26D are present between the seventh gap 136 and the eighth gap 138. The two tight fit portions 180, 182 are spaced apart from each other in the axial direction, and the first tight fit portion 180 is located above the second tight fit portion 182. The first tight fit portion 180 and the second tight fit portion 182 may have a tight fit margin of substantially 5 μm. The second tight fit portion 182 is located between the first radial dynamic pressure generating grooves 156 and the second radial dynamic pressure generating grooves 158 in the axial direction. As to the positional relationship between the upper end 108C and the radial dynamic pressure generating portions, the upper end 108C is located above the upper end of the first radial dynamic pressure generating portion 156.

An explanation will be given of an operation of the disk drive device 100 employing the above-explained structure. Three-phase drive currents are applied to the coils 42 to rotate the magnetic recording disk 8. When such drive currents flow through the respective coils 42, magnetic fluxes are generated along the nine salient poles. Those magnetic fluxes apply torque to the cylindrical magnet 32, and thus the rotator and the magnetic recording disk 8 engaged therewith rotate. While at the same time, when the voice coil motor 16 causes the swing arm 14 to swing, the recording/playing head goes out and comes in the swingable range over the magnetic recording disk 8. The recording/playing head converts magnetic data recorded in the magnetic recording disk 8 into electrical signals, and transmits the signals to a control board (unillustrated), or writes data transmitted in the form of electrical signals from the control board in the magnetic recording disk 8 as magnetic data.

Next, a detailed explanation will be below given of advantageous effects of this embodiment.

According to the disk drive device 100 of this embodiment, the shaft fastening screw 6 that fastens the top cover 2 to the shaft 26 is engaged with, in a screw manner, the shaft-fastening-screw hole 152 formed in the support protrusion 108. Hence, according to the structure in which the shaft 26 is supported by the support protrusion 108, the engagement length of the shaft fastening screw 6 and the shaft-fastening-screw hole 152 can be elongated without increasing the thickness of the disk drive device 100. Accordingly, the joining strength between the shaft fastening screw 6 and the support protrusion 108 can be enhanced, thereby improving the shock resistance and the vibration resistance.

In addition, according to the disk drive device 100 of this embodiment, the support protrusion 108 extends up to substantially same height as that of the flange 26G in the axial direction. Moreover, the upper end 108C of the support protrusion 108 is located above the first radial dynamic pressure generating portion 156. Hence, the portion where the outer circumference 108A of the support protrusion 108 and the circumferential surface of the support hole 26D face with each other in the radial direction can be elongated. This enhances the joining strength between the shaft 26 and the support protrusion 108.

Still further, according to the disk drive device 100 of this embodiment, the portion where the outer circumference 108A of the support protrusion 108 and the circumferential surface of the support hole 26D face with each other in the radial direction has the two tight fit portions 180, 182 held between the two gaps 136, 138. Accordingly, when the shaft 26 is fitted with the support protrusion 108, the fitting can be advanced initially with relatively small force, and when the fitting advances to some levels, press-fitting starts. Hence, in comparison with a case in which press-fitting starts from the beginning, the shaft 26 can be easily joined with the support protrusion 108 while maintaining the squareness of the shaft 26. That is, the initial free-play condition serves as a guide for press-fitting, and thus the press-fitting work which can maintain the squareness is facilitated.

According to the disk drive device 100 of this embodiment, the shaft 26 is fastened to the support protrusion 108 by both press-fitting and bonding. Hence, the joining strength can be further enhanced in comparison with a case in which only one of such techniques is applied.

According to the disk drive device 100 of this embodiment, the second tight fit portion 182 is located between the first radial dynamic pressure generating portion 156 and the second radial dynamic pressure generating portion 158 in the axial direction. Hence, even if the shaft 26 expands due to stress produced at the second tight fit portion 182, the expansion hardly affects to the first and second radial dynamic pressure generating portions 156, 158.

In general, the bypass communication hole 164 is formed by piercing the shaft encircling portion 28J from the top or the bottom using a drill or laser. In general, after the piercing, spot facing is often applied in order to eliminate edge burrs present around the edge of the hole. This is because to prevent the edge burrs from being peeled and entering the dynamic pressure generating portions, thereby eliminating an adverse effect to the dynamic pressure generation.

However, as to an external part of the upper-end edge of the bypass communication hole 164 present in the first recessed face 154A, spot facing is difficult or takes a time even if possible since the first recessed face 154A is inclined relative to the direction in which the bypass communication hole 164 runs. Hence, according to the disk drive device 100 of this embodiment, the edge-corresponding recess 178 is formed in the ring 104. Hence, after the formation of the bypass communication hole 164, even if edge burrs are left at the external part of the upper-end edge of the bypass communication hole 164, it becomes possible to reduce a possibility that such edge burrs contact the element of the stationary body and is peeled.

In addition, according to the disk drive device 100 of this embodiment, spot facing is applied to a remaining portion 164C of the upper-end edge of the bypass communication hole 164. Hence, the possibility that the edge burrs are peeled from this area can be reduced. Moreover, the edge-corresponding recess 178 is formed at a remote location from the remaining portion 164C. Hence, in comparison with a case in which the edge-corresponding portion is large enough to cover the remaining portion 164C, the edge-corresponding recess 178 is prevented from affecting the flow of the lubricant 92 and the dynamic pressure thereof while maintaining the effect of suppressing a peeling of the edge burrs. As a result, the designing of the disk drive device 100 is further facilitated.

According to the disk drive device 100 of this embodiment, the second gas-liquid interface 120 of the lubricant 92 is present in the ninth gap 140. Hence, the tapered seal is permitted to overlap the radial dynamic pressure generating portion in the axial direction. This enables an enlargement of a distance in the axial direction between the first radial dynamic pressure generating portion 156 and the second radial dynamic pressure generating portion 158, i.e., a bearing span substantially regardless of the length of the tapered seal. Therefore, the radial rigidity of the bearing can be enhanced.

Conversely, the length of the tapered seal can be increased substantially regardless of the bearing span, and thus a sufficient amount of the lubricant 92 can be retained. In addition, the lubricant 92 can be prevented from spilling out. When the amount of the lubricant 92 to be retained can be reduced, the ninth gap 140 and the fourth gap 132 can be narrowed by what corresponds to the reduction of the lubricant 92. This increases the capillary force which reduces a leak-out of the lubricant 92 when, for example, shock is applied.

According to the disk drive device 100 of this embodiment, the bottom 4M is provided at the lower end of the bearing hole 4K, and blocks off the bearing hole 4K. Hence, the air-tightness of the clean space 24 can be increased. Accordingly, it becomes possible to prevent gases with a smaller molecular weight than nitrogen, such as helium or hydrogen, filled in the clean space 24 from leaking from the bearing hole 4K.

According to the disk drive device 100 of this embodiment, the cover ring 12 is provided with a lubricant trap (unillustrated). Hence, the vaporized lubricant 92 is trapped in the lubricant trap provided at the cover ring 12. Therefore, a sticking of the lubricant to the magnetic recording disk 8 can be suppressed.

Still further, according to the disk drive device 100 of this embodiment, the lubricant 92 contains fluorescent materials. Accordingly, when input light with a predetermined wavelength is emitted to the lubricant 92, visible light with a different wavelength from the input light is emitted. This facilitates an inspection of the liquid level of the lubricant 92, and also a detection of a sticking of the lubricant 92 and a leak-out thereof.

The structure of the disk drive device and the operation thereof according to this embodiment were explained. The embodiment is merely an example, and a combination of structural elements in the embodiment permits various modifications, and it should be understood for those skilled in the art that such modifications are also within the scope and spirit of the present invention.

In the aforementioned embodiment, the explanation was given of a so-called outer-rotor disk drive device having the cylindrical magnet 32 located outwardly relative to the laminated core 40, but the present invention is not limited to this structure. For example, the present invention is applicable to a so-called inner-rotor disk drive device having the cylindrical magnet located inwardly relative to the laminated core.

In the aforementioned embodiment, although the explanation was given of an example case in which the laminated core is employed, a so-called single-piece core, etc., may be employed.

Although the explanation was given of an example case in which the shaft body is supported by the base in the aforementioned embodiment, the present invention is applicable to a so-called rotating-shaft disk drive device having the shaft body rotating together with the hub.

In the aforementioned embodiment, the explanation was given of an example case in which the hub is formed of a ferrous material, but the present invention is not limited to this case. In order to make the hub lightweight, for example, the hub may be formed of a non-ferrous metal like an aluminum alloy or a resin material like a liquid crystal polymer. When the hub is formed of a non-magnetic material, a substantially cylindrical yoke formed of a magnetic material may be provided between the hub and the cylindrical magnet.

In the aforementioned embodiment, the explanation was given of an example case in which the shaft encircling portion 28J is formed integrally with the hub 4, but the present invention is not limited to this case. In order to optimize the manufacturing process, respective portions of the hub may be formed by different schemes, and may be joined together by a predetermined technology. Examples of such a joining include bonding, shrink fitting, welding, and a combination of equal to or greater than two those schemes.

In the aforementioned embodiment, the explanation was given of an example case in which the thrust dynamic pressure generating grooves are formed in the shaft encircling portion 28J, but the present invention is not limited to this case. In order to optimize the manufacturing process, a thrust member that will rotate together with the hub 28, and an opposing member supported by the base 4 in a fixed manner and facing the thrust member in the axial direction may be separately prepared, and the thrust dynamic pressure generating grooves may be formed in the thrust member instead of the shaft encircling portion 28J. For example, the thrust member is formed integrally with the shaft encircling portion 28J by cut-out.

Although the explanation was given of an example case in which the gas dynamic pressure generating grooves 58 are formed in the lower face 28P of the mount portion 28H, the present invention is not limited to this case. In order to optimize the manufacturing process, the gas dynamic pressure generating grooves may be formed in either one of a surface portion of the hub supported by the base in a fixed manner or a surface portion thereof facing the former portion in the radial direction or in the axial direction.

In the aforementioned embodiment, the explanation was given of an example case in which the flange 26G encircles the upper end 108C of the support protrusion 108, but the present invention is not limited to this case. For example, the shaft fastening screw may be engaged with a screw hole in a screw manner provided in the shaft, and the tip of such a shaft fastening screw may further enter a center hole formed in the support protrusion, and, may be bonded and fixed thereto.

In the aforementioned embodiment, the explanation was given of an example case in which the electromechanical machining is applied to the hub 28, but in view of a further elimination of the possible peeling materials, the electromechanical machining may be applied to the clamper 36. More specifically, when the clamper 36 is engaged with the outer circumference 28D of the hub 28 by screwing, process burrs, etc., may be peeled from an inner circumference 36B of the clamper 36. Hence, In order to eliminate such process burrs beforehand, it is advantageous if electromechanical machining is applied to at least the inner circumference 36B of the clamper 36.

In the embodiment illustrated in the figures, the explanation was given of an example case in which one magnetic recording disk 8 is to be mounted on the hub 28, but the present invention is not limited to this structure. The present invention is also applicable to a structure in which multiple magnetic recording disks 8 are to be mounted on the hub 28. In this case, a spacer with a predetermined thickness may be placed between the respective magnetic recording disks 8.

The manufacturing method of the disk drive device 100 permit various modifications for the elimination of the possible peeling materials sticking to the surface of the hub protrusion 28G. For example, instead of electromechanical machining to the outer circumference of the cut-out hub protrusion 28G, the outer circumference of the cut-out hub protrusion 28G may be shot or blasted by shot abrasives to eliminate the possible peeling materials. In particular, it is effective if the male-screw forming area of the hub protrusion 28G is shot or blasted by shot abrasives. In this case, the possible peeling materials in the male-screw forming area can be effectively eliminated. The shot abrasives are not limited to any particular kinds, but as an example, dry ice is applicable. Since dry ice is vaporized and diffused after collision, a contamination of the hub 28 can be avoided. In addition, as an example, the shot abrasives may be salt like sodium hydrogen carbonate. It is suitable since sodium hydrogen carbonate can be easily removed by rinsing.

What is claimed is:

1. A manufacturing method of a disk drive device that comprises:
a base;
a hub comprising a hub protrusion to be engaged with a center of the recording disk, and a mount portion on which the recording disk is to be mounted; and
a fluid dynamic bearing unit that supports the hub in a freely rotatable manner relative to the base, the method comprising:
cutting a surface of the hub protrusion; and
applying electromechanical machining to an outer circumference of the cut-out hub protrusion.

2. The disk drive device manufacturing method according to claim 1, wherein the hub comprises a thread formed on the outer circumference of the hub protrusion.

3. The disk drive device manufacturing method according to claim 1, further comprising:
applying electromechanical machining to the mount portion.

4. The disk drive device manufacturing method according to claim 3, wherein an electromechanical machining applied level of an electromechanical machined surface of the hub protrusion is larger than an electromechanical machining applied level of an electromechanical machined surface of the mount portion.

5. The disk drive device manufacturing method according to claim 1, wherein:
the fluid dynamic bearing unit comprises a shaft, and a shaft encircling member that encircles the shaft;
a radial fluid dynamic pressure generating groove is disposed in an inner circumference of the shaft encircling member; and
the method further comprises:
applying electromechanical machining to the radial fluid dynamic pressure generating groove.

6. The disk drive device manufacturing method according to claim 5, further comprising:
cutting the shaft encircling member and the hub to form the shaft encircling member integral with the hub.

7. The disk drive device manufacturing method according to claim 1, wherein:
the fluid dynamic bearing unit comprises a thrust member that rotates together with the hub;
the thrust member comprises a thrust face that faces in an axial direction an opposing component supported by the base in a stationary manner;
a thrust fluid dynamic pressure generating groove is disposed in the thrust face of the thrust member; and
the method further comprises:
applying electromechanical machining to the thrust fluid dynamic pressure generating groove.

8. The disk drive device manufacturing method according to claim 7, further comprising:
cutting out the shaft encircling member to form the thrust member integral with the shaft encircling member.

9. The disk drive device manufacturing method according to claim 1, wherein:
the hub comprises a gas dynamic pressure generating groove which is formed in a part of the hub facing the base in an axial direction and which generates dynamic pressure to a gas; and
the method further comprises:
applying electromechanical machining to the gas dynamic pressure generating groove.

10. A manufacturing method of a disk drive device that comprises:
a base;
a hub comprising a hub protrusion to be engaged with a center of the recording disk, a mount portion on which the recording disk is to be mounted, and a thread formed on an outer circumference of the hub protrusion; and
a fluid dynamic bearing unit that supports the hub in a freely rotatable manner relative to the base, the method comprising:
cutting a surface of the hub protrusion to form the thread; and
applying electromechanical machining to the outer circumference of the cut hub protrusion and the thread.

11. The disk drive device manufacturing method according to claim 10, further comprising:
applying electromechanical machining to the mount portion.

12. The disk drive device manufacturing method according to claim 11, wherein an electromechanical machining applied level of an electromechanical machined surface of the hub protrusion is larger than an electromechanical machining applied level of an electromechanical machined surface of the mount portion.

13. The disk drive device manufacturing method according to claim 10, wherein:
the fluid dynamic bearing unit comprises a shaft, and a shaft encircling member that encircles the shaft;
a radial fluid dynamic pressure generating groove is disposed in an inner circumference of the shaft encircling member; and
the method further comprises:
applying electromechanical machining to the radial fluid dynamic pressure generating groove.

14. The disk drive device manufacturing method according to claim 13, further comprising:
cutting the shaft encircling member and the hub to form the shaft encircling member integral with the hub.

15. The disk drive device manufacturing method according to claim 10, wherein:
the fluid dynamic bearing unit comprises a thrust member that rotates together with the hub;
the thrust member comprises a thrust face that faces in an axial direction an opposing component supported by the base in a stationary manner;
a thrust fluid dynamic pressure generating groove is disposed in the thrust face of the thrust member; and
the method further comprises:
applying electromechanical machining to the thrust fluid dynamic pressure generating groove.

16. The disk drive device manufacturing method according to claim 15, further comprising:
cutting out the shaft encircling member to form the thrust member integral with the shaft encircling member.

17. The disk drive device manufacturing method according to claim 15, wherein:
the hub comprises a gas dynamic pressure generating groove which is formed in a part of the hub facing the base in an axial direction and which generates dynamic pressure to a gas; and
the method further comprises:
applying electromechanical machining to the gas dynamic pressure generating groove.

18. A manufacturing method of a disk drive device that comprises:
a base;
a hub comprising a hub protrusion to be engaged with a center of the recording disk, a mount portion on which the recording disk is to be mounted, and a thread formed on an outer circumference of the hub protrusion; and
a fluid dynamic bearing unit that supports the hub in a freely rotatable manner relative to the base, the method comprising:
cutting a surface of the hub protrusion to form the thread; and
shooting shot abrasives to the cut hub protrusion and the thread.

19. The disk drive device manufacturing method according to claim 18, wherein the shot abrasives comprise dry ices.

20. The disk drive device manufacturing method according to claim 18, wherein the shot abrasives comprise sodium hydrogen carbonate.
